(19) United States
(12) Patent Application Publication
(10) Pub. No.: US 2022/0237191 A1
(43) Pub. Date: Jul. 28, 2022

(54) SYSTEM AND METHOD FOR SUPPORTING VERY LARGE DATA SETS IN DATABASES

(71) Applicant: salesforce.com, inc., San Francisco, CA (US)

(72) Inventor: Seth John White, San Francisco, CA (US)

(73) Assignee: salesforce.com, inc., San Francisco, CA (US)

(21) Appl. No.: 17/157,967

(22) Filed: Jan. 25, 2021

(51) Int. Cl. G06F 16/2453

(52) U.S. Cl. CPC G06F 16/24535; G06Q 10/10

(57) ABSTRACT

A method and system of querying a partitioned data set organized in a static hierarchy. The method includes receiving a query for data in the partitioned data set at a first node, applying the query to a virtual data set of the first node to determine at least one child node having a child virtual data set with data for the query, generating at least one sub query for the at least one child node, where the at least one sub query is based on the query, and sending the at least one sub query to the at least one child to process.

### TECHNICAL FIELD

One or more implementations relate to the field of database management; and more specifically, to a process and method for efficiently handling very large data sets in databases.

### BACKGROUND ART

A database is an organized collection of data that is stored in a machine-readable medium. The data can be accessed from the machine-readable medium by various types of electronic devices. The data collection, or data set, can have any organization or structure. The amount of data that can be managed by the database can vary depending on the limitations of the machine-readable medium, and the software utilized to manage the data set.

The software for managing the data set can be referred to as a database management system (DBMS). The DBMS interacts with users of the database, applications, and the database itself to store, process, and retrieve the data set. The DBMS software also includes basic functions to administer the database, such as configuration tools, data processing functions, and similar functions. The combination of the database, the DBMS, and the associated applications and processes, can be referred to as a ‘database system.’ The term “database” is also commonly used to refer to any combination of the DBMS, the database itself, the database system, or applications associated with the database system.

Database-management systems can be classified based on the database model that they support or implement. Relational databases or derivatives thereof are in common usage. The relational databases and other types of databases model or organize the data set as rows and columns in a set of tables. Most database systems utilize a formal query language such as the structured query language (SQL) or similar query languages for accessing, storing, and manipulating the data set. Various types of non-relational databases are also in common use, some of which utilize different types of query languages referred to as non-SQL (NoSQL) query languages.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a diagram of one example implementation of a database system that supports large data sets.

FIG. 2 is a diagram of one example implementation of a partitioned data set.

FIG. 3 is a diagram of another example implementation of a partitioned data set.

FIG. 4 is a diagram of one example implementation of a set of hosts to manage an example query in the database system.

FIG. 5 is a flowchart of one example implementation of a process query process for large data set.

FIG. 6 is a flowchart of one example implementation of a process for partitioning a large data set.

FIG. 7A is a block diagram illustrating an electronic device according to some example implementations.

FIG. 7B is a block diagram of an environment where a data base system that supports very large data sets may be deployed, according to some implementations.

### DETAILED DESCRIPTION

The following description describes methods and apparatus for enabling a database system to implement extremely large tables, tables that include billions or trillions of rows. The method and apparatus provide a method to query the very large table with subsecond response times. The size and speed of the tables can be used to support various functions such as analytics (e.g., to provide a “speed of thought” dashboard experience for analytics users). The method supports queries on multiple tables that make up the extremely large tables. The methods and apparatus further include processes for how such tables are managed, created, staged, and/or queried, in a cloud environment or similar distributed computing environment. The methods and apparatus utilize a hierarchical data set. The term “data set,” as used herein refers to tables that are horizontally and vertically partitioned in the data base system and queried using a query language (e.g., the Salesforce Analytics Query Language (SAQL), by Salesforce.com, Inc and SQL languages). These processes and structures are further detailed herein.

The term “user” is a generic term referring to an entity (e.g., an individual person) using a system and/or service. A multi-tenant architecture provides each tenant with a dedicated share of a software instance and the ability (typically) to input tenant specific data for user management, tenant-specific functionality, configuration, customizations, non-functional properties, associated applications, etc. Multi-tenancy contrasts with multi-instance architectures, where separate software instances operate on behalf of different tenants. A tenant includes a group of users who share a common access with specific privileges to a software instance providing a service. A tenant may be an organization (e.g., a company, department within a company, etc.). A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers. A user may have one or more roles relative to a system and/or service. To provide some examples, a user may be a representative (sometimes referred to as an “end user”) of a tenant (e.g., a vendor or customer), a representative (e.g., an administrator) of the company providing the system and/or service, and/or a representative (e.g., a programmer) of a third-party application developer that is creating and maintaining an application(s) on a Platform as a Service (PAAS).

Overview

The methods and apparatus provide a system for generating and storing large data sets, as well as processing queries on the large data sets. The term ‘galactic’ data set is used herein to describe a large data set with between 2 billion and 999 trillion rows. A database system that can handle these galactic data sets have various advantages enabling users and administrators to expand data sets and have long term scalability.

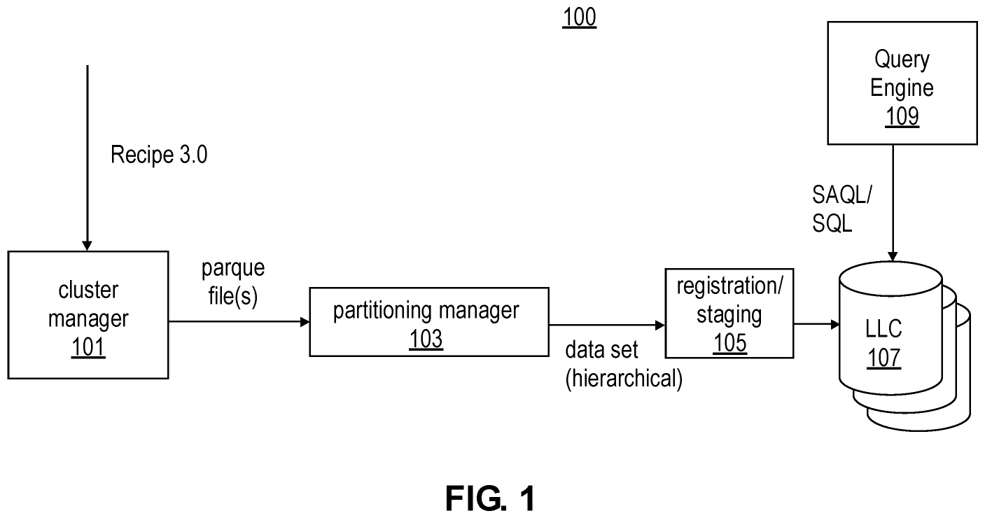

FIG. 1 is a diagram of one example implementation of a database system that support the handling of galactic data sets. The database system 100 includes a cluster manager 101, partitioning manager 103, registration 105, a set of low latency clusters (LLC) 107, and a query engine 109. The query engine 109 is one of several components of the database system that must support the galactic data sets for the database system 100 to function for the galactic data sets. In addition to the query engine 109, the processes for creating, registering, and staging the data sets will support the galactic data sets to enable the query engine 109 to be able to access and utilize the galactic data sets.

The database system 100 partitions the galactic data sets. A cluster manager (e.g., Apache Spark) can be utilized to process an input recipe and data. The recipe is a set of instructions to pre-process the incoming galactic data set to prepare the data for storage. The example of a recipe is provided herein by way of example and not limitation. A ‘recipe’ can also be a data flow or similar representation. The cluster manager generates a denormalized version of the galactic data set to be stored as a hierarchical data set. The cluster manager 101 produces parquet, optimized row columnar (ORC), or similar files that contain the output of the recipe. There will generally be more than one parquet or similar file output by the cluster manager for a galactic data set. In this case, each parquet or similar file represents a chunk of the output data.

The cluster manager must be scalable and able to produce the parquet or similar files for a galactic data set in a reasonable amount of time. The parquet or similar files can be produced out of whole-cloth by a single recipe run, or as the result of multiple recipe runs that execute append operations.

The parquet or similar files are then processed by a partitioning manager 103. The partitioning manager 103 processes the parquet or similar files output by the cluster manager 101. In some cases, the partition manager 103 can output a single data set, but for galactic data sets the number of rows in the data set would exceed row limits for most components of the database system 100 (e.g., a billion row limit or similar limit can be an upper bound on data set size for components of the data base system 100). The partitioning manager 103 can handle partitioning of the galactic data set, and create a partitioned data set directly. The partitioned data set that partitioning manager 103 creates will be a hierarchical data set for data sets with more than two billion rows or a similar limit. Hierarchical data sets are defined herein below. The partition manager 103 can support multiple parquet or similar input files and can translate N parquet or similar files into a data set with M partitions. The partitions that are created can have any size. In some implementations, the partition sizes are uniform and less than the limits on the data set size for other components of the data base system 100.

The output partitions from the partition manager 103 can be processed by a register 105. A galactic data set is registered after it is created and/or partitioned. The term ‘register’ or ‘registered’ as used herein refers to placing a copy of the data in a system of record, so that the data can survive failure events. In some implementations, an ‘unpartitioned’ and partitioned version of the galactic data set can be registered. This double registration can be done for partitioned data sets so that the unpartitioned copy could be used as input to a traditional dataflow. However, database systems 100 that are entirely compatible with partitioned galactic data sets may not have this duplicated registration. Galactic data sets are not produced or consumed by traditional data flows. They are produced and consumed by recipes or similar instruction sets.

The parquet (output) version of the data can be copied to the system of record (SOR) (i.e., registered) to ensure that it can be used as input to another recipe in the future. The partitioned data set can be copied to the SOR in order to ensure that it can be used by the query engine in the future. However, copying both is expensive. An alternative is to just copy one or the other and generate data in the unsaved format from the data that was saved in the case the other format is needed. This would be a rare circumstance, since failure events (e.g., a system crash, or data center being destroyed by an earthquake) are relatively rare.

The register 105 can operate according to different possible implementations. The register 105 can process the parquet or similar files used to create the hierarchical data set. The disadvantage of this is that it means registering a lot more data than if the register 105 processed the partitioned data set exclusively. Alternatively, the register could re-create the parquet or similar files from the hierarchical data set, if the hierarchical data set is ever used as input to a recipe. This reduces the amount of data that is registered, but adds the overhead of re-creating the parquet or similar files. In some implementations, the approach to the registration of using the parquet or similar files can be the best option where registration is a bottleneck and it is possible that large data sets will not often be used as input to other recipes. A hybrid implementation could also be utilized. All virtual data sets and partitions will be registered, however, only the top level virtual data set will be visible to users.

In some implementation, a staging component (e.g., Maestro Analytics by Encoda) can stage the registered data set. In some implementations the registration and staging can be combined or separately implemented. The staging component can copy the files representing the galactic data set to a set of worker nodes (e.g., iworkers) in a reasonable amount of time and update the database in the low latency cluster (LLC) 107 (e.g., Apache Cassandra) to record the locations of partitions in the database. When this registration and staging process is complete the galactic data set is ready to be queried. Galactic data sets can have lots of partitions. A ten billion row data set can have 100 partitions if the partition size is 100 million rows and each partition is replicated. There needs to be enough disks, memory, and CPU resources in the low-latency cluster to support this number of partitions.

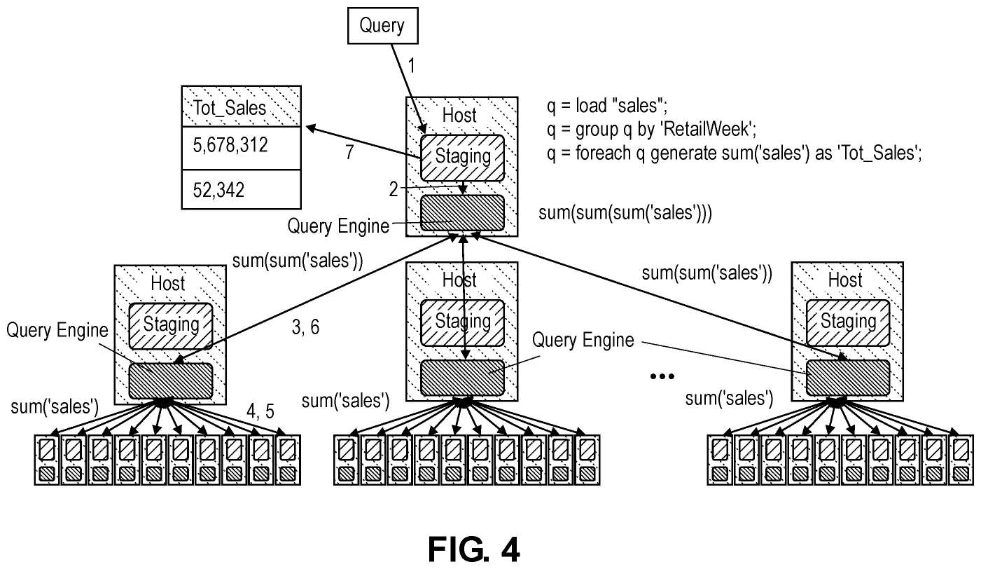

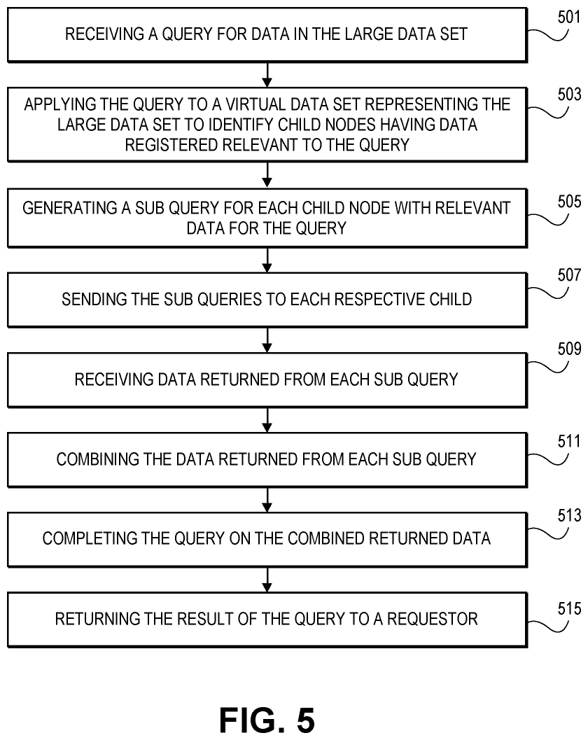

In the example implementations, the query engine 109 is able to query data sets which can contain 2 billion, 10 billion, 100 billion, or more rows. The process of querying hierarchical data sets is further described herein below with reference to FIGS. 4 and 5. From the user perspective hierarchical data sets are queried using SAQL, SQL or similar query language in exactly the same way as other data sets.

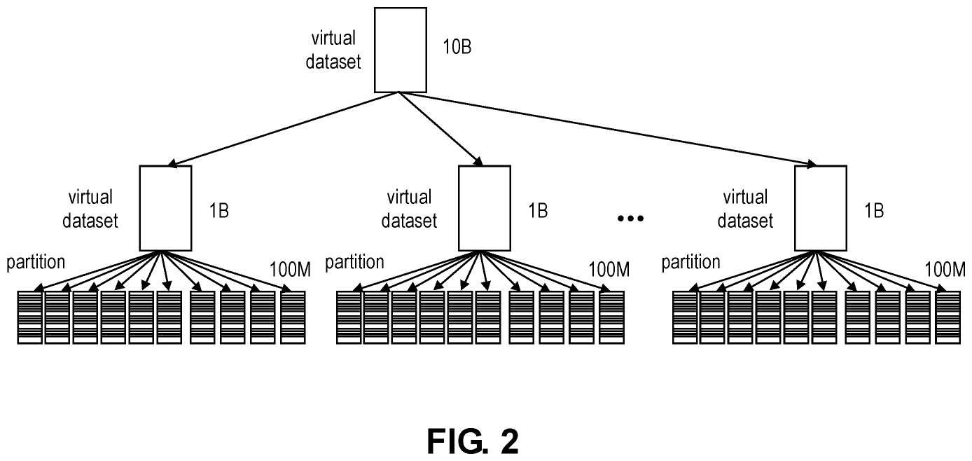

FIG. 2 is a diagram of one example implementation of a hierarchical data set. The hierarchical data set is a data structure that enables data sets to scale to tens and hundreds of billions of rows. This provides the ‘galactic-scale’ for galactic data sets, i.e., data sets with as many rows as galaxies have stars. A hierarchical data set can be a generalization of a partitioned data set.

In some implementations, a hierarchical data set is a balanced, n-ary tree. The leaf nodes are called “partitions” and are the partitions of the partitioned galactic data set. A partition is a regular data set that contains all the data set artifacts of traditional data sets in a database system (e.g., main.json, dimension (.dat) files, dimension index (.idx) files, measure files, multi-value indexes, date-part dimensions, and similar information). The partitions are where the actual data is stored and are where most query processing work will occur. Each partition holds part of the data set, a subset of the rows (a hierarchical data set is a large, denormalized table) that makes up the hierarchical data set. Conceptually, a round robin (random robin) algorithm can be used to assign rows to a partition. The interior nodes of a hierarchical data set are called “virtual” data sets. A virtual data set has data registry information (e.g., a main.json file), but does not contain data. There are no actual data files in a virtual data set. Like a regular data set, the registry information (e.g., the main.json file) for a virtual data set contains the metadata that defines the scope of the data within the data of virtual data set. The registration information (e.g., main.json) specifies the number of rows in the virtual data set (sum of the number of rows in all child data sets), what dimensions and measures (i.e. columns) exist, and various attributes of these rows and/or columns such as the dimension cardinality, and the number of null values in a measure, among information. The registry information (e.g., main.json) contains all of the metadata that the query engine needs to compile a query and generate a distributed query plan.

The distributed query plan defines the sub-queries that are sent to child data sets during query execution to return data needed by the overall query execution plan. In addition, the metadata for a virtual data set lists the child data sets that make up the virtual data set. A child data set can be another virtual data set or a partition (leaf node). This is possible because data sets are an abstraction in the example implementations of the database system. Every data set is logically a large denormalized table with rows and columns. The shape of the contents of the abstraction are defined by the registry information (e.g., the main.json metadata file). It makes no difference if the child data set is another virtual data set or a partition (i.e., a real data set containing actual data) from the perspective of the parent when executing a query.

Turning to the example of FIG. 2, the diagram shows a hierarchical data set that contains 10 billion rows. The top-level virtual data set is composed of 10 child data sets that each contain 1 billion rows. The registry information (e.g., main.json files) for the virtual data sets each specify the number of rows they contain, e.g., 10 billion for the parent and 1 billion for its children. The registry information (e.g., main.json files) for all of the virtual data sets will contain the same set of columns since they are part of the same table, however, the metadata that describes the columns may vary. For example, the cardinality for a dimension may vary between parent and child data sets, depending on what rows a child data set actually contains.

The metadata describing the number of null values in a measure and the minimum and maximum value of the measure may also vary between child data sets. This is due to the fact that each child data set contains a different set of rows in the table. Each of the 1 billion row virtual data sets has 10 children in FIG. 2. In this case, there are 100 leaf nodes which each contain 100 million rows (100×100 M=10 B). In general, there is no limit on the number of levels that a hierarchical data set may have.

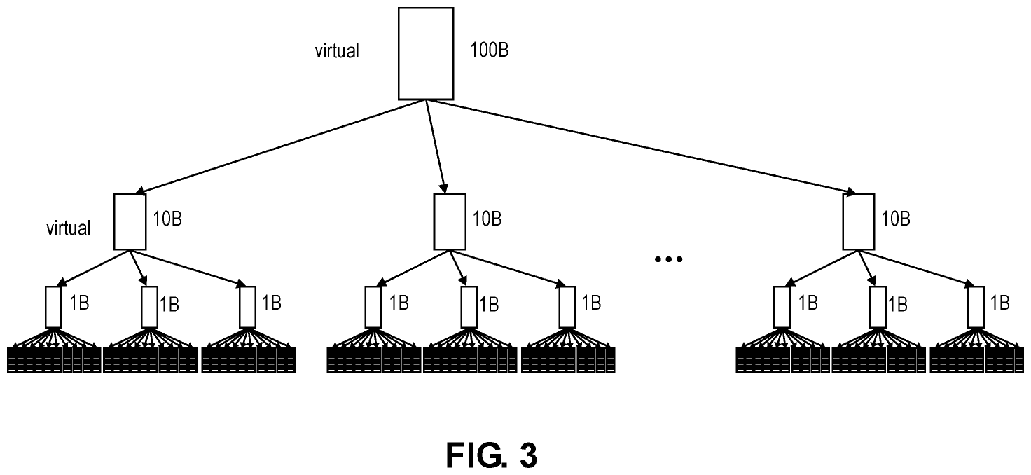

FIG. 3 is a diagram of an example implementation of a hierarchical data set that contains 100 billion rows. In this case there is one additional level when compared to the data set in FIG. 2, for a total of 3 total levels. One level for each virtual data set layer. The top level virtual data set contains 100 billion rows. The child data sets each contain 10 billion rows, and their children contain 1 billion rows, on down to the partitions which each contain 100 million rows. In the example, it is assumed that each parent data set can have a maximum of 10 child data sets. This is provided by way of example and not limitation. In other implementations, a parent can have any number of children, however, in some cases there can be a limit to how many children a parent can manage efficiently when queries are processed. The example implementation also assumes that the partitions contain 100 million rows. In other implementations, partitions can contain any number of rows.

In some implementations, a formula can govern the number of levels in a hierarchical data set as shown in FIG. 3. The formula for the number of partitions in some implementations can be:

let r=the number of rows in the data set

let m=the minimum partition size

let c=the max number of children

then

p=the number of partitions=┌r/m┐

1=the number of levels=┌log c p┐

Using the example data set in FIG. 2 and the formulas above, the formula has

p=┌10 B/100 M┐=100

1=┌log 10 100┐=2

And using the data set in FIG. 1,

p=┌100 B/100 M┐=1000

1=┌log 10 1000┐=3

Thus, the number of levels in the hierarchical data set grows very slowly. A 1 trillion row data set would only have 4 levels. Each level can add up to 20 ms latency, then the overhead for the hierarchical structure is very small 40 ms for queries on a 10 B row data set.

The query engine executes queries received from applications, end users, and similar sources. Queries may access one or more data sets. A query is compiled into a distributed query plan if any of the data sets accessed by the query are partitioned. Distributed query plan execution is, in turn, broken down into pre and post-projection phases. As used herein, ‘projection’ refers to converting the data from columnar to row format. The conversion can occur at different points during a query. The processing on columnar data can be pushed down to the children in some implementation, however in other implements but in other embodiments the processing can occur at other points.

All post-projection processing is handled locally on the host that runs the original query. In some implementations, pre-projection processing that involves a hierarchical data set follows the static structure of the hierarchical data set. In other implementations, the database system dynamically creates the equivalent of virtual data sets based on the particular query. The execution flow is top-down beginning at the root virtual data set and eventually reaching the partitions. Requests for data are transmitted from parent to child in the form of a high level query (e.g., an SAQL query).

Using a high level language to represent the parts of a distributed query, referred to herein as subqueries, has several advantages. It decouples the parent functions from the child functions. The child can have all of the responsibility and control needed for optimizing and executing a subquery. The parent does not need to know if the child is another virtual data set or partition. The parent execution of the query can be limited to understand logically what data is returned by the subquery.

With this query process, there are two cases that are encountered in executing queries that involves a hierarchical data. The case where the query or subquery is applied to a virtual data sets and the case where the query (or subquery) is applied to a partition.

The processing that takes place for a partition when executing a sub-query is standard for the processing that is done for a regular query over a non-partitioned data set. The partition is a regular data set. The staging component (e.g., Maestro) is used to route processing to a host assigned to a partition when the partition was staged. In this way, distributed query execution can leverage all of the support that already exists for query routing and execution. In addition, the process is augmented to track subquery execution for load-balancing purposes. Any type of query operations can be pushed down to partitions including scanning, filtering, grouping, aggregation, projection, sorting, limit, offset, and similar queries.

For the second case of applying queries to virtual data sets, a virtual data set is registered like a regular data set and query requests are routed to a host assigned to a virtual data set by the staging component. The processing that takes place is different, however, compared to the processing that is done for a regular data set. In this case, the query is compiled and optimized and a distributed query plan is generated. The distributed query plan is executed by sending sub-queries to hosts that contain child data sets to retrieve data. The data returned is then further processed, the results from the child data sets are combined, and the query result is returned to the caller.

The example implementations can use a technique that can be referred to as “hierarchical aggregation.” In the database system, sub-queries on child data sets return partial aggregate values and these partial aggregate values are combined during query processing at each virtual data set layer. The example in the next section illustrates how this works for the sum( ) aggregate function. Other aggregate functions can be implemented in a similar manner including min, max, avg, first, last, and similar functions used in database queries.

For some aggregate functions, like stddev, the partial aggregate value is a set of values that represent a portion of the stddev calculation. The values are combined to form a quantity that represents the calculation done by all of the children. Another class of functions are unique and percentile. For these functions, the underlying values are returned and the aggregation happens at the top-level virtual data set.

FIG. 4 is a diagram of one example implementation of an example query by a set of hosts in a database system. In one example, a query is processed for groups sales data by week and returns the total sales for each week. This example contains no post-projection work. All of the operations in the query can be pushed down. Query execution begins when the query is received (stage 1). The staging component routes control to a host assigned to the ‘sales’ data set, i.e. the top-level virtual data set in the hierarchical data set (stage 2). The ‘sales’ data set contains 10 billion rows and has the same topology as the data set in FIG. 2.

The query engine compiles the query and generates a distributed query plan based on the registration information (e.g., main.json) for the top level data set. The metadata of the registration information describes all of the columns in the table and lists the partitions to which subqueries will be sent to retrieve data. The distributed query is a directed graph of query operators.

The portions of the graph that need to be executed on child data sets are then de-compiled back into the query language (e.g., SAQL) and sent in parallel as new query requests (stage 3). The diagram shows how quickly parallelism builds up as execution proceeds. In the diagram, the subquery sent to each of the 10 child data sets is compiled in parallel and a distributed query plan is generated, because each child data set is also a partitioned data set, in parallel. the partitioned data sets contain 1 billion rows. In some implementations, the sub-query can be identical to the original query since all query operations are pushed down with one exception: the data set id in the load statement now references the child data set. Next, a second round of sub-queries are sent in parallel to the children of these virtual data sets (stage 4).

Execution is proceeding in parallel at 100 hosts in the cluster (LLC). A property of the hierarchical data set approach is the ability to harness the full power of a cluster of machines in this way. Since all query operations are pushed down, the sub-query that reaches each partition is again the same as the original query, except that the load statement now references the partition.

The same top-down flow of execution can be utilized for any and all queries on the partitioned, hierarchical data set. The only difference between queries is the processing that happens once control reaches the partitions (and the data that flows backup the tree). The subquery is executed in parallel at all 100 partition hosts and the result is returned (stage 5). In this example, each row in the subquery result returned from a partition contains a week and a partial sum of sales for that week. As control returns back up the tree (stage 6), the sums are summed together at each host, ultimately producing the correct, overall query output at the top level.

In this example, partial sums are combined. Other aggregate functions are also combined, such as min( ) —a min of child mins is computed. Other functions such as stddev (standard deviation) and var (variance) require more sophisticated mathematical techniques to combine, but the process is conceptually the same, partial values for each group are combined to form a higher level partial value which becomes the final value at the top level of the tree. For unique and percentile functions, or similar functions, an array of values is returned and used at the top level to compute the final value for the function. In the illustrated example there are only 2 weeks. The first week has total sales of 5,678,312. The second week has total sales of 52,342.

FIG. 5 is a flowchart of one implementation of the query process of the database system. The query process can be triggered by receiving a query for data in a large (i.e., galactic) data set managed by the database system (Block 501). The query can be in any query language (e.g., SAQL, SQL, or similar query language). The query can be received via a terminal, API, or similar interface for the database system. The host of the data set in the database system, i.e., the highest level of the hierarchy, is identified and provided the query to process. The process of the host is the same at a root of a hierarchy and at intermediate nodes. If the host is not a leaf node, then the host determines a plan for generating subqueries to be sent to each of the child nodes that have relevant data (Block 503). The generation of subqueries can be specific to the type of query being processed. The child nodes with relevant data in the data set can be determined based on registration information or similar meta data in the virtual data set that details the range of data associated with each child node.

The subqueries for each identified child node are generated (Block 505) and sent to the respective child nodes (Block 507). The parent node then awaits return of information from each of its child nodes. If the host node is a leaf node, then the host node can execute the received query on the data set associated with the host node and return the results to a parent node or the entity that generated the query.

Where subqueries have been sent to child nodes, the host node receives the returned data for the subqueries from each child node that processed a sub query (Block 509). The returned data can then be combined according to the functions of the query (Block 511). The combined data can be processed (Block 513) and returned to the entity that generated the query where the host node is the root of the hierarch (Block 515). If the host node is not root node, then the combined and processed returned data can be returned to the parent of the host node.

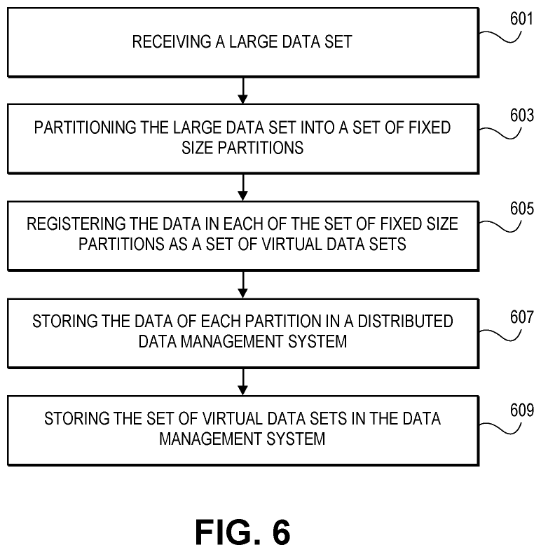

FIG. 6 is a flowchart of one example implementation of the process for generating a partitioned galactic data set. The process of generating the partitioned data set can be initiated in response to receiving a large (i.e., galactic) data set by a cluster manager or similar component of the data base system (Block 601). The cluster manager can pass the large data set to a partitioning component that partitions the large data set into a set of fixed size partitions (Block 603). The partitions and the levels of the hierarchy of the hierarchical data organization can be fixed and static to facilitate fast and efficient usage of the large data set. The partitions can be registered, such that the range of data in each partition and similar characteristics is captured as meta data for each partition as well as each virtual data set of parent nodes in the hierarchical tree structure of the data set (Block 605). Each of the partitions is assigned to a host in the database system (Block 607). Similarly, each of the virtual data sets of the root and intermediate nodes are similarly assigned to a host in the database system (Block 609).

Exemplary Electronic Devices

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

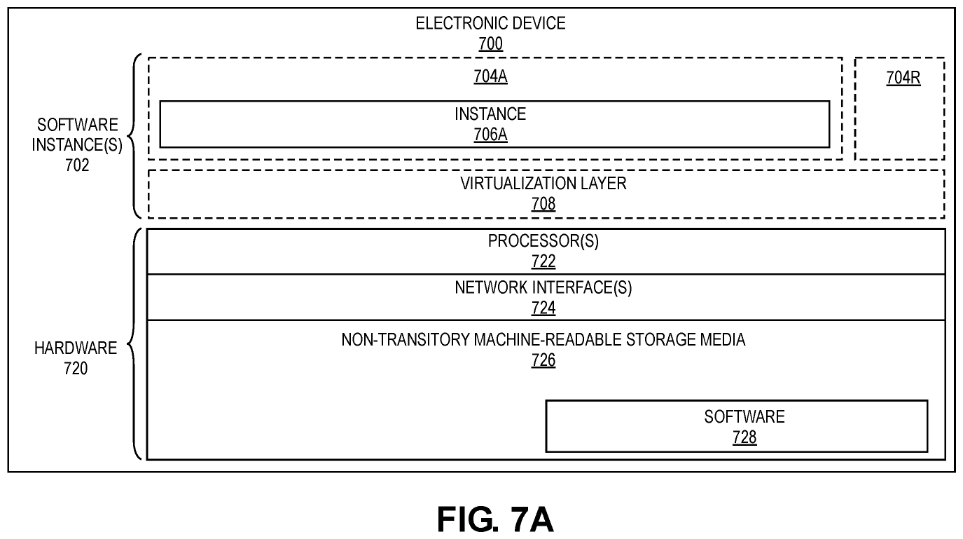

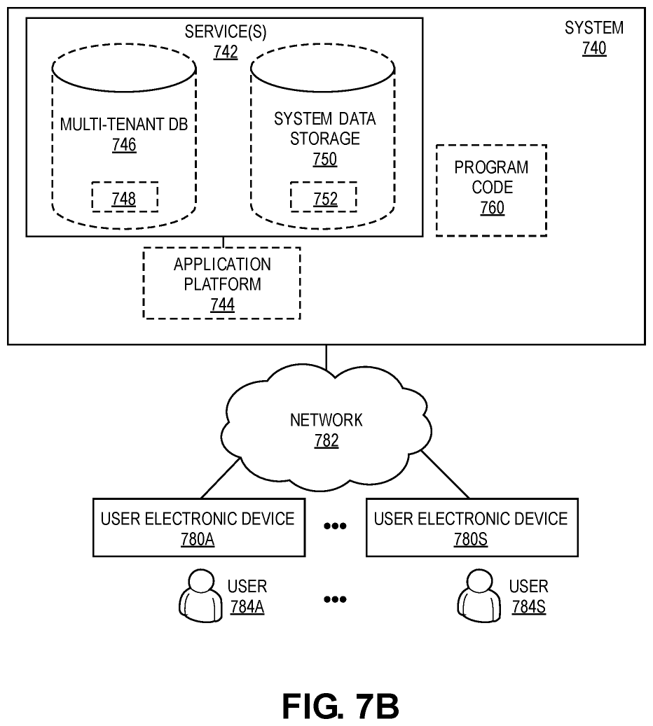

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and non-transitory machine-readable storage media 726 having stored therein software 728 (which includes instructions executable by the set of one or more processor(s) 722). Each of the previously described end user clients and the galactic database service may be implemented in one or more electronic devices 700. In one implementation: 1) each of the end user clients is implemented in a separate one of the electronic devices 700 (e.g., in user electronic devices operated by users where the software 728 represents the software to implement end user clients to interface with the galactic database service (e.g., a web browser, a native client, a portal, a command-line interface, and/or an application program interface (API) based upon protocols such as Simple Object Access Protocol (SOAP), Representational State Transfer (REST), etc.)); 2) the galactic database service is implemented in a separate set of one or more of the electronic devices 700 (e.g., a set of one or more server electronic devices where the software 728 represents the software to implement the galactic database service); and 3) in operation, the electronic devices implementing the end user clients and the galactic database service would be communicatively coupled (e.g., by a network) and would establish between them (or through one or more other layers) connections for submitting queries to the galactic database service and returning query results to the end user clients. Other configurations of electronic devices may be used in other implementations (e.g., an implementation in which the end user client and the galactic database service are implemented on a single electronic device 700).

In electronic devices that use compute virtualization, the set of one or more processor(s) 722 typically execute software to instantiate a virtualization layer 708 and software container(s) 704A-R (e.g., with operating system-level virtualization, the virtualization layer 708 represents the kernel of an operating system (or a shim executing on a base operating system) that allows for the creation of multiple software containers 704A-R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 728 (illustrated as instance 706A) is executed within the software container 704A on the virtualization layer 708. In electronic devices where compute virtualization is not used, the instance 706A on top of a host operating system is executed on the “bare metal” electronic device 700. The instantiation of the instance 706A, as well as the virtualization layer 708 and software containers 704A-R if implemented, are collectively referred to as software instance(s) 702.

Alternative implementations of an electronic device may have numerous variations from that described above. For example, customized hardware and/or accelerators might also be used in an electronic device.

Network Device

A network device (ND) is an electronic device that communicatively interconnects other electronic devices on the network (e.g., other network devices, user electronic devices, server electronic devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Exemplary Environment

FIG. 7B is a block diagram of an environment where a galactic database service may be deployed, according to some implementations. A system 740 includes hardware (a set of one or more electronic devices) and software to provide service(s) 742, including the galactic database service. The system 740 is coupled to user electronic devices 780A-S over a network 782. The service(s) 742 may be on-demand services that are made available to one or more of the users 784A-S working for one or more other organizations (sometimes referred to as outside users) so that those organizations do not need to necessarily be concerned with building and/or maintaining a system, but instead makes use of the service(s) 742 when needed (e.g., on the demand of the users 784A-S). The service(s) 742 may communication with each other and/or with one or more of the user electronic devices 780A-S via one or more Application Programming Interface(s) (APIs) (e.g., a Representational State Transfer (REST) API). The user electronic devices 780A-S are operated by users 784A-S.

In one implementation, the system 740 is a multi-tenant cloud computing architecture supporting multiple services, such as a galactic database service, a customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 740 may include an application platform 744 that enables PAAS for creating, managing, and executing one or more applications developed by the provider of the application platform 744, users accessing the system 740 via one or more of user electronic devices 780A-S, or third-party application developers accessing the system 740 via one or more of user electronic devices 780A-S.

In some implementations, one or more of the service(s) 742 may utilize one or more multi-tenant databases 746 for tenant data 748, as well as system data storage 750 for system data 752 accessible to system 740. In certain implementations, the system 740 includes a set of one or more servers that are running on server electronic devices and that are configured to handle requests for any authorized user associated with any tenant (there is no server affinity for a user and/or tenant to a specific server). The user electronic device 780A-S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the one or more multi-tenant database 746 and/or system data storage 750.

In some implementations, the service(s) 742 are implemented using virtual applications dynamically created at run time responsive to queries from the user electronic devices 780A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the galactic database service, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 740 and the user electronic devices 780A-S.

Each user electronic device 780A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 740. For example, the user interface device can be used to access data and applications hosted by system 740, and to perform searches on stored data, and otherwise allow a user 784 to interact with various GUI pages that may be presented to a user 784. User electronic devices 780A-S might communicate with system 740 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 780A-S might include an HTTP client, commonly referred to as a “browser,” for sending and receiving HTTP messages to and from server(s) of system 740, thus allowing users 784 of the user electronic device 780A-S to access, process and view information, pages and applications available to it from system 740 over network 782.

### CONCLUSION

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method of querying a partitioned data set organized in a static hierarchy, the method comprising:
receiving a query for data in the partitioned data set at a first node;
applying the query to a virtual data set of the first node to determine at least one child node having a child virtual data set with data for the query;
generating at least one sub query for the at least one child node, where the at least one sub query is based on the query; and
sending the at least one sub query to the at least one child to process.

2. The method of claim 1, wherein the virtual data set of the first node includes a register of data in the partitioned data set that is managed by a plurality of child nodes of the first node.

3. The method of claim 1, further comprising;
receiving data returned from the at least one sub query; and
combining the data returned from the at least one sub query with data returned from other sub queries.

4. The method of claim 3, further comprising:
applying the query to the combined data; and
returning the result of the query to a requestor.

5. A method of storing a partitioned data set organized in a static hierarchy, the method comprising:
receiving a large data set to be stored in data management system;
partitioning the large data set into a set of fixed sized partitions;
registering data in each of the set of fixed size partitions as a set of virtual data sets;
storing each partition of the set of fixed size partitions in the data management system; and
storing the set of virtual data sets in the data management system.

6. The method of claim 5, wherein the set of virtual data sets have a fixed hierarchy.

7. The method of claim 6, wherein the fixed hierarchy is a tree structure having a root node with a virtual data set with registered data for each child virtual data set.

8. The method of claim 6, wherein leaves of the tree structure are the fixed sized partitions.

9. A non-transitory machine-readable storage medium that provides instructions that, if executed by a processor, will cause the processor to perform operations of a method of querying a partitioned data set organized in a static hierarchy, the operations comprising:
receiving a query for data in the partitioned data set at a first node;
applying the query to a virtual data set of the first node to determine at least one child node having a child virtual data set with data for the query;
generating at least one sub query for the at least one child node, where the at least one sub query is based on the query; and
sending the at least one sub query to the at least one child to process.

10. The non-transitory machine-readable storage medium of claim 9, wherein the virtual data set of the first node includes a register of data in the partitioned data set that is managed by a plurality of child nodes of the first node.

11. The non-transitory machine-readable storage medium of claim 9, that provides further instructions that, if executed by a processor, will cause the processor to perform operations of a method of querying a partitioned data set organized in a static hierarchy, the operations comprising:
receiving data returned from the at least one sub query; and
combining the data returned from the at least one sub query with data returned from other sub queries.

12. The non-transitory machine-readable storage medium of claim 11 that provides instructions that, if executed by a processor, will cause the processor to perform operations of a method of querying a partitioned data set organized in a static hierarchy, the operations comprising:
applying the query to the combined data; and
returning the result of the query to a requestor.

13. The non-transitory machine-readable storage medium of claim 9, that provides further instructions that, if executed by a processor, will cause the processor to perform operations of a method of querying a partitioned data set organized in a static hierarchy, the operations comprising:
receiving a large data set to be stored in data management system;
partitioning the large data set into a set of fixed sized partitions;
registering data in each of the set of fixed size partitions as a set of virtual data sets;
storing each partition of the set of fixed size partitions in the data management system; and
storing the set of virtual data sets in the data management system.

14. The non-transitory machine-readable storage medium of claim 13, wherein the set of virtual data sets have a fixed hierarchy.

15. The non-transitory machine-readable storage medium of claim 14, wherein the fixed hierarchy is a tree structure having a root node with a virtual data set with registered data for each child virtual data set.

16. The non-transitory machine-readable storage medium of claim 14, wherein leaves of the tree structure are the fixed sized partitions.

17. A computing device to execute a method of querying a partitioned data set organized in a static hierarchy, the computing device comprising:
a non-transitory machine-readable medium having stored therein a query manager; and
a processor coupled to the non-transitory machine-readable medium, the processor to execute the query manager, the query manager to receive a query for data in the partitioned data set at a first node, apply the query to a virtual data set of the first node to determine at least one child node having a child virtual data set with data for the query, generate at least one sub query for the at least one child node, where the at least one sub query is based on the query, and send the at least one sub query to the at least one child to process.

18. The computing device of claim 17, wherein the virtual data set of the first node includes a register of data in the partitioned data set that is managed by a plurality of child nodes of the first node.

19. The computing device of claim 17, wherein the query manger is further to receive data returned from the at least one sub query, and combine the data returned from the at least one sub query with data returned from other sub queries.

20. The computing device of claim 19, wherein the query manager is further to apply the query to the combined data, and return the result of the query to a requestor.

21. A computing device to implement a method of storing a partitioned data set organized in a static hierarchy, the computing device comprising:
a non-transitory machine-readable storage medium having stored therein a partition manager; and
a processor coupled to the non-transitory machine-readable storage medium, the processor to execute the partition manager, the partition manager to receive a large data set to be stored in data management system, partition the large data set into a set of fixed sized partitions, register data in each of the set of fixed size partitions as a set of virtual data sets, store each partition of the set of fixed size partitions in the data management system, and store the set of virtual data sets in the data management system.

22. The computing device of claim 21, wherein the set of virtual data sets have a fixed hierarchy.

23. The computing device of claim 22, wherein the fixed hierarchy is a tree structure having a root node with a virtual data set with registered data for each child virtual data set.

24. The computing device of claim 22, wherein leaves of the tree structure are the fixed sized partitions.
